(19) United States
(12) Patent Application Publication
(10) Pub. No.: US 2008/0026182 A1
(43) Pub. Date: Jan. 31, 2008

(54) HARD-COATED FILM, POLARIZING PLATE AND IMAGE DISPLAY INCLUDING THE SAME, AND METHOD OF MANUFACTURING HARD-COATED FILM

(75) Inventors: Hideo ABE, Ibaraki-shi (JP); Makoto TASAKI, Ibaraki-shi (JP); Seiichi KUSUMOTO, Ibaraki-shi (JP); Masayuki SATAKE, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 11/828,708

(22) Filed: Jul. 26, 2007

(30) Foreign Application Priority Data
Jul. 26, 2006 (JP) 2006-202731

(51) Int. Cl. B32B 7/12; B05D 5/10

(52) U.S. Cl. 428/141; 427/208; 428/343

(57) ABSTRACT

A hard-coated film is provided that has a high hardness and excellent elasticity and flexibility, can be prevented from curling due to curing and shrinking of the hard-coating layer, and can be bonded to the surfaces of various displays. A hard-coating layer is formed on one surface of a transparent plastic film substrate and a pressure-sensitive adhesive layer is formed on the other surface of the substrate. The hard-coating layer is formed of a material for forming a hard-coating layer. The material contains Components A, B, and C. Component A is at least one of urethane acrylate and urethane methacrylate. Component B is at least one of polyol acrylate and polyol methacrylate. Component C is a polymer containing a repeating unit represented by General Formula 1 indicated below:

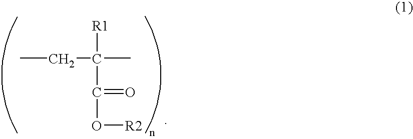

### CROSS-REFERENCE TO RELATED APPLICATIONS

This application claims priority from Japanese Patent Application No. 2006-202731 filed on Jul. 26, 2006. The entire subject matter of the Japanese Patent Application is incorporated herein by reference.

### FIELD OF THE INVENTION

The present invention relates generally to hard-coated films, polarizing plates and image displays including the same, and method of manufacturing hard-coated films.

### BACKGROUND OF THE INVENTION

With technical improvement in recent years, liquid crystal displays (LCDs), plasma display panels (PDPs), electroluminescence displays (ELDs), etc. have been developed in addition to conventional cathode ray tubes (CRTs) as image displays and have been used in practical applications. As LCDs have been technically improved to provide wide viewing angles, high resolution, high response, good color reproduction, and the like, applications of LCDs are spreading from laptop personal computers and monitors to television sets. In a basic LCD structure, a pair of flat glass substrates each provided with a transparent electrode are opposed via a spacer to form a constant gap, between which a liquid crystal material is placed and sealed to form a liquid crystal cell, and a polarizing plate is formed on the outside surface of each of the pair of glass substrates. In a conventional technique, a glass or plastic cover plate is attached to the surface of the liquid crystal cell in order to prevent scratches on the polarizing plate bonded to the surface of the liquid crystal cell. However, the placement of such a cover plate is disadvantageous in terms of cost and weight. Thus, the implementation of a hard coating process to treat the surface of polarizing plates has been gradual. Flat panel displays such as LCDs are employed for the display parts of various electrical appliances and thereby there is a demand for improving the hardness of display surfaces. For instance, in a notebook-sized personal computer in which an LCD is employed, if the surface of a polarizing plate does not have a sufficiently high hardness, the mark of the keyboard is left on the polarizing plate when it is closed, and this becomes one of the causes that deteriorate visibility.

For the hard coating process, a hard-coated film is generally used in which a thin hard-coating layer with a thickness of 2 to 30 μm has been formed on one or both surfaces of a transparent plastic film substrate. Generally, the hard-coating layer is formed using resins for forming a hard-coating layer such as thermosetting resins or ultraviolet (UV)-curable resins. If such resins are applied to a glass plate to form the hard-coating layer, it can exhibit a pencil hardness of 4H or more. If a hard-coating layer with an insufficient thickness is formed on a transparent plastic film substrate, however, the pencil hardness of the layer can be generally affected by the substrate and reduced to 3H or less.

When the hardness of the outermost surface of the polarizing plate employed in a commercial LCD is not sufficiently high, the user prevents scratches by bonding a hard-coated film with a pressure-sensitive adhesive thereto after purchase. For example, it has been proposed that a transparent resin sheet subjected to a curing treatment is bonded to the surface of a cathode-ray tube as a film to be bonded to the outermost surface of a display, with a pressure-sensitive adhesive layer being interposed therebetween (see JP 52(1977)-87352 A). However, the hard-coated film with a pressure-sensitive adhesive may not have a sufficiently high hardness in some cases.

The improvement in hardness of the hard-coated film can be achieved by increasing the thickness of a hard-coating layer. However, the increase in thickness of the hard-coating layer results in a deterioration in elasticity and flexibility and causes the hard-coated film to curl due to curing and shrinking of the hard-coating layer during the formation thereof, and as a result, it cannot be used in practical application, which has been a problem.

A hard-coated film that has a high hardness as well as excellent elasticity and flexibility, that can be prevented from curling due to curing and shrinking of a hard-coating layer, and that can be bonded to the surfaces of various image displays. The present invention is also intended to provide a polarizing plate and an image display including the same, and method of manufacturing a hard-coated film.

### SUMMARY OF THE INVENTION

In order to achieve the above-mentioned object, a hard-coated film of the present invention includes a transparent plastic film substrate and a hard-coating layer that is formed on one surface of the transparent plastic film substrate. The hard-coating layer further includes a pressure-sensitive adhesive layer formed on the other surface of the transparent plastic film substrate. The hard-coating layer is formed using a material for forming the hard-coating layer. The material contains the following Component A, Component B, and Component C:
Component A: at least one of urethane acrylate and urethane methacrylate;
Component B: at least one of polyol acrylate and polyol methacrylate; and
Component C: a polymer or copolymer that is formed of at least one of
Components C1 and C2 described below, or a mixed polymer of the polymer and the copolymer,
where Component C1 is alkyl acrylate having an alkyl group containing at least one of a hydroxyl group and an acryloyl group, and
Component C2 is alkyl methacrylate having an alkyl group containing at least one of a hydroxyl group and an acryloyl group.

A polarizing plate of the present invention includes a hard-coated film stacked on one side thereof. The hard-coated film is the aforementioned hard-coated film of the present invention.

An image display of the present invention includes at least one of a hard-coated film of the present invention and a polarizing plate of the present invention.

A method of manufacturing a hard-coated film comprising a transparent plastic film substrate and a hard-coating layer formed on one surface of the transparent plastic film substrate. The method comprises: preparing a material for forming the hard-coating layer containing Component A, Component B, and Component C that have been dissolved or dispersed in a solvent; forming a coating film by applying the material for forming the hard-coating layer onto one surface of the transparent plastic film substrate; forming the hard-coating layer by curing the coating film, and forming a pressure-sensitive adhesive layer onto the other surface of the transparent plastic film substrate.
Component A: at least one of urethane acrylate and urethane methacrylate,
Component B: at least one of polyol acrylate and polyol methacrylate, and
Component C: a polymer or copolymer that is formed of at least one of Components C1 and C2 described below, or a mixed polymer of the polymer and the copolymer,
Component C1: alkyl acrylate having an alkyl group containing at least one of a hydroxyl group and an acryloyl group, and
Component C2: alkyl methacrylate having an alkyl group containing at least one of a hydroxyl group and an acryloyl group.

The aforementioned three components function conjointly to allow the hard-coated film of the present invention to have a sufficiently high hardness as well as excellent elasticity and flexibility, and to be prevented from curling due to curing and shrinking of the hard-coating layer. However, the present invention is not limited to this. Improvements in the properties of a hard-coated film achieved by the present invention can be due to the combination of the aforementioned three components and improvements in the properties of a hard-coated film achieved by the present invention can be due to the aforementioned three components separately. For Example, the material for forming the hard-coating layer contains Component A, which can impart elasticity and flexibility to the hard-coating layer to be formed, for example; the material contains Component B, which can allow the hard-coating layer to be formed to have a sufficiently improved hardness and excellent scratch resistance, for example; and the material contains Component C, which can prevent curling from occurring by alleviating curing and shrinking during the formation of the hard-coating layer, for example. The hard-coated film of the present invention can be bonded to various image displays easily since it includes a pressure-sensitive adhesive layer formed therein. The functions and effects of these respective components are described as mere examples and therefore the descriptions thereof do not limit the present invention.

### BRIEF DESCRIPTION OF THE DRAWINGS

FIG. 1 is a cross-sectional view schematically showing the structure of a hard-coated film according to one embodiment of the present invention;

FIG. 2 is a cross-sectional view schematically showing the structure of a hard-coated film according to another embodiment of the present invention;

FIG. 3 is a cross-sectional view schematically showing the structure of a hard-coated film according to a further embodiment of the present invention;

FIG. 4 is a cross-sectional view schematically showing the structure of a hard-coated film according to a still further embodiment of the present invention; and

FIG. 5 is a schematic view showing an example of the relationship among the roughness curve, height h, and standard length L.

### DESCRIPTION OF THE EMBODIMENTS

In the hard-coated film and the method of manufacturing the same of the present invention, it is preferable that Component B contain at least one of pentaerythritol triacrylate and pentaerythritol tetraacrylate. This is because it allows sufficiently high hardness and flexibility to be maintained while curling can be more effectively prevented from occurring.

In the hard-coated film and the method of manufacturing the same of the present invention, it is preferable that Component C contain a polymer or copolymer containing a repeating unit represented by General Formula (1) indicated below, or a mixture of the polymer and the copolymer. This is because curling can be prevented from occurring more effectively. 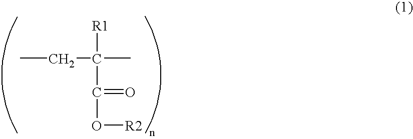
In General Formula (1), R1 denotes —H or —CH₃, R2 denotes —CH₂CH₂OX or a group that is represented by General Formula (2) indicated below. 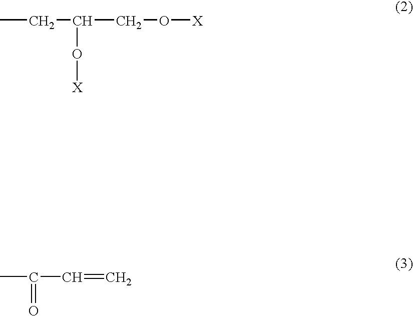
In General Formula (2), the X denotes —H or an acryloyl group that is represented by General Formula (3) above, and Xs are identical to or different from each other.

In the hard-coated film and the method of manufacturing the same of the present invention, it is preferable that the outer surface of the hard-coating layer have an uneven structure. When the outer surface of the hard-coating layer has an uneven structure, the hard-coated film can exhibit antiglare properties. The uneven structure can be formed by adding fine particles to the material for forming the hard-coating layer, for example.

In the hard-coated film and the method of manufacturing the same of the present invention, in order to reduce the reflection of light at the interface between the hard-coating layer and air, an antireflection layer can be formed on the outer surface of the hard-coating layer. When a hard-coated film provided with an antireflection layer is used, for example, in an image display, it is possible to improve the visibility of images on the display screen.

Next, the present invention is described in detail. The present invention, however, is not limited by the following description.

The hard-coated film of the present invention is configured to have a hard-coating layer on one surface of a transparent plastic film substrate and a pressure-sensitive adhesive layer on the other surface.

The transparent plastic film substrate is not particularly limited. Preferably, the transparent plastic film substrate has a high visible-light transmittance (preferably a light transmittance of at least 90%) and good transparency (preferably a haze value of at most 1%). Examples of the material for forming the transparent plastic film substrate include polyester type polymers, cellulose type polymers, polycarbonate type polymers, acrylic type polymers, etc. Examples of the polyester type polymers include polyethylene terephthalate, polyethylenenaphthalate, etc. Examples of the cellulose type polymers include diacetyl cellulose, triacetyl cellulose (TAC), etc. Examples of the acrylic type polymers include poly methylmethacrylate, etc. Examples of the material for forming the transparent plastic film substrate also include styrene type polymers, olefin type polymers, vinyl chloride type polymers, amide type polymers, etc. Examples of the styrene type polymers include polystyrene, acrylonitrile-styrene copolymer, etc. Examples of the olefin type polymers include polyethylene, polypropylene, polyolefin that has a cyclic or norbornene structure, ethylene-propylene copolymer, etc. Examples of the amide type polymers include nylon, aromatic polyamide, etc. The material for forming the transparent plastic film substrate may also contain, for example, imide type polymers, sulfone type polymers, polyether sulfone type polymers, polyether-ether ketone type polymers, polyphenylene sulfide type polymers, vinyl alcohol type polymers, vinylidene chloride type polymers, vinyl butyral type polymers, allylate type polymers, polyoxymethylene type polymers, epoxy type polymers, blend polymers of the above-mentioned polymers, etc. Among them, those having small optical birefringence are used suitably. The hard-coated film of the present invention can be used as a protective film for a polarizing plate, for example. In such a case, the transparent plastic film substrate is preferably a film formed of triacetyl cellulose, polycarbonate, an acrylic polymer, a polyolefin having a cyclic or norbornene structure, etc. In the present invention, as described below, the transparent plastic film substrate may be a polarizer itself. Such a structure does not need a protective layer of TAC or the like and provides a simple polarizing plate structure and thus allows a reduction in the number of steps for manufacturing polarizing plates or image displays and an increase in production efficiency. In addition, such a structure can provide thinner polarizing plates. When the transparent plastic film substrate is a polarizer, the hard-coating layer serves as a protective layer in a conventional manner. In such a structure, the hard-coated film also functions as a cover plate, when attached to the surface of various image displays such as a liquid crystal display.

In the present invention, the thickness of the transparent plastic film substrate is not particularly limited. For example, the thickness is preferably 10 to 500 μm, more preferably 20 to 300 μm, and most suitably 30 to 200 μm, in terms of strength, workability such as handling property, and thin layer property. The refractive index of the transparent plastic film substrate is not particularly limited The refractive index is, for example, 1.30 to 1.80, preferably 1.40 to 1.70.

The hard-coating layer is formed using a material for forming the hard-coating layer containing Component A, Component B, and Component C described below:
Component A: at least one of urethane acrylate and urethane methacrylate;
Component B: at least one of polyol acrylate and polyol methacrylate; and
Component C: a polymer or copolymer that is formed of at least one of Components C1 and C2 described below, or a mixed polymer of the polymer and the copolymer,
Component C1: alkyl acrylate having an alkyl group containing at least one of a hydroxyl group and an acryloyl group, and
Component C2: alkyl methacrylate having an alkyl group containing at least one of a hydroxyl group and an acryloyl group.

Examples of the urethane acrylate and urethane methacrylate of Component A include those containing constituents such as acrylic acid, methacrylic acid, acrylic acid ester, methacrylic acid ester, a polyol, and a diisocyanate. For example, at least one of the urethane acrylate and urethane methacrylate can be produced by using a polyol and at least one monomer selected from acrylic acid, methacrylic acid, acrylic acid ester, and methacrylic acid ester, preparing at least one of a hydroxyacrylate having at least one hydroxyl group and a hydroxymethacrylate having at least one hydroxyl group, and allowing it to react with a diisocyanate. In Component A, one type of urethane acrylate or urethane methacrylate may be used alone, or two types or more of them may be used in combination.

Examples of the acrylic acid ester include alkyl acrylates, cycloalkyl acrylates, etc. Examples of the alkyl acrylates include methyl acrylate, ethyl acrylate, isopropyl acrylate, butyl acrylate, etc. Examples of the cycloalkyl acrylates include cyclohexyl acrylate, etc. Examples of the methacrylic acid ester include alkyl methacrylates, cycloalkyl methacrylates, etc. Examples of the alkyl methacrylates include methyl methacrylate, ethyl methacrylate, isopropyl methacrylate, butyl methacrylate, etc. Examples of the cycloalkyl methacrylates include cyclohexyl methacrylate, etc.

The polyol is a compound having at least two hydroxyl groups. Examples of the polyol include ethylene glycol, 1,3-propylene glycol, 1,2-propylene glycol, diethylene glycol, dipropylene glycol, neopentyl glycol, 1,3-butanediol, 1,4-butanediol, 1,6-hexanediol, 1,9-nonanediol, 1,10-decanediol, 2,2,4-trimethyl-1,3-pentanediol, 3-methyl-1,5-pentanediol, neopentylglycol hydroxypivalate ester, cyclohexane dimethylol, 1,4-cyclohexanediol, spiroglycol, tricyclodecane methylol, hydrogenated bisphenol A, ethylene oxide-added bisphenol A, propylene oxide-added bisphenol A, trimethylolethane, trimethylolpropane, glycerin, 3-methylpentane-1,3,5-triol, pentaerythritol, dipentaerythritol, tripentaerythritol, glucoses, etc.

The diisocyanate to be used herein can be any type of aromatic, aliphatic, or alicyclic diisocyanate. Examples of the diisocyanate include tetramethylene diisocyanate, hexamethylene diisocyanate, isophorone diisocyanate, 2,4-tolylene diisocyanate, 4,4-diphenyl diisocyanate, 1,5-naphthalene diisocyanate, 3,3-dimethyl-4,4-diphenyl diisocyanate, xylene diisocyanate, trimethyl hexamethylene diisocyanate, 4,4-diphenylmethane diisocyanate, and hydrogenated derivatives thereof.

The ratio of Component A to be added is not particularly limited. The use of Component A can improve the flexibility of the resulting hard-coating layer and adhesion of the resulting hard-coating layer with respect to the transparent plastic film substrate. From such viewpoints and the viewpoint of hardness of the hard-coating layer, the ratio of Component A to be added can be, for example, 15 to 55% by weight, preferably 25 to 45% by weight, with respect to the entire resin components in the material for forming the hard-coating layer. The term “entire resin components” denotes the total amount of Components A, B, and C, or when other resin components are used, a sum of the total amount of the aforementioned three components and the total amount of the resin components. The same applies below.

Examples of Component B include pentaerythritol diacrylate, pentaerythritol triacrylate, pentaerythritol tetraacrylate, dipentaerythritol hexaacrylate, 1,6-hexanediol acrylate, pentaerythritol dimethacrylate, pentaerythritol trimethacrylate, pentaerythritol tetramethacrylate, dipentaerythritol hexamethacrylate, 1,6-hexanediol methacrylate, etc. These can be used alone. Alternatively, two or more of them can be used in combination. Preferred examples of the polyol acrylate include a monomer component containing a polymer of pentaerythritol triacrylate and pentaerythritol tetraacrylate, and a component mixture containing pentaerythritol triacrylate and pentaerythritol tetraacrylate.

The ratio of Component B to be added is not particularly limited. The ratio of Component B to be added is preferably 70 to 180% by weight and more preferably 100 to 150% by weight, with respect to the amount of Component A. When the ratio of Component B to be added is 180% by weight or less with respect to the amount of Component A, the hard-coating layer to be formed can be effectively prevented from hardening and shrinking. As a result, the hard-coated film can be prevented from curling and the flexibility thereof can be prevented from deteriorating. When the ratio of Component B to be added is at least 70% by weight with respect to the amount of Component A, the hard-coating layer to be formed can have further improved hardness and improved scratch resistance. In the hard-coated film of the present invention, the scratch resistance is preferably in the range of 0 to 0.7 and more preferably in the range of 0 to 0.5. Measurement of the scratch resistance can be carried out by, for instance, the measurement method described later in the section of Examples.

In Component C, the alkyl groups of Components C1 and C2 are, for example, alkyl groups with a carbon number of 1 to 10. The alkyl groups can be of a straight chain, or can be of a branched-chain. Examples of Component C include a polymer or copolymer containing a repeating unit represented by General Formula (1) described above, or a mixture of the polymer and the copolymer. Examples of Component C include a polymer, a copolymer, and a mixture of the polymer and the copolymer, with the polymer and a copolymer being formed of at least one monomer selected from the group consisting of 2,3-dihydroxypropyl acrylate, 2,3-diacryloyloxypropyl acrylate, 2-hydroxy-3-acryloyloxypropyl acrylate, 2-acryloyloxy-3-hydroxypropyl acrylate, 2,3-dihydroxypropyl methacrylate, 2,3-diacryloyloxypropyl methacrylate, 2-hydroxy-3-acryloyloxypropyl methacrylate, 2-acryloyloxy-3-hydroxypropyl methacrylate, 2-hydroxyethyl acrylate, 2-acryloyloxyethyl acrylate, 2-hydroxyethyl methacrylate, and 2-acryloyloxyethyl methacrylate.

The ratio of Component C to be added is not particularly limited. For example, the ratio of Component C to be added is preferably 25 to 110% by weight and more preferably 45 to 85% by weight, with respect to the amount of Component A. When the ratio of Component C to be added is 110% by weight or lower with respect to the amount of Component A, the material for forming the hard-coating layer has excellent coating properties. When the ratio of Component C to be added is at least 25% by weight with respect to the amount of Component A, the hard-coating layer to be formed can be prevented from hardening and shrinking. As a result, in the hard-coated film, curling can be controlled, for example, within 30 mm or less. The degree at which curling occurs is preferably within 20 mm or less and more preferably within 10 mm or less. The evaluation of the occurrence of curling can be carried out by, for instance, the method described later in the section of Examples.

As described above, the hard-coating layer may contain fine particles to have an uneven structure at its surface. This is because when having a surface with an uneven structure, the hard-coating layer can be provided with antiglare properties. The fine particles can be inorganic or organic fine particles, for example. The inorganic fine particles are not particularly limited. Examples of the inorganic fine particles include fine particles made of silicon oxide, titanium oxide, aluminum oxide, zinc oxide, tin oxide, calcium carbonate, barium sulfate, talc, kaolin, calcium sulfate, etc. The organic fine particles are not particularly limited. Examples thereof include polymethyl methacrylate resin powder (PMMA fine particles), silicone resin powder, polystyrene resin powder, polycarbonate resin powder, acrylic-styrene resin powder, benzoguanamine resin powder, melamine resin powder, polyolefin resin powder, polyester resin powder, polyamide resin powder, polyimide resin powder, polyethylene fluoride resin powder, etc. One type of the inorganic and organic fine particles can be used alone, or two types or more of them can be used in combination.

The fine particles may have any shape. They may be in the form of approximately spherical beads or may be of an indefinite shape such as powder, for example. The fine particles may have a weight average particle size of, for example, 1 to 30 μm, preferably 2 to 20 μm. The weight average particle size of the fine particles is preferably 30 to 75% of the thickness of the hard-coating layer, more preferably 30 to 50% of the thickness. When the weight average particle size of the fine particles is at least 30%, sufficient unevenness can be formed on the surface, and sufficient antiglare function can be provided. When the weight average particle size of the fine particles is 75% or lower, the surface unevenness can be advantageous, the appearance can be good, and reflected light can be scattered advantageously. The fine particles preferably have a substantially spherical shape, more preferably a substantially spherical shape with an aspect ratio of 1.5 or lower.

The ratio of the fine particles to be added is not particularly limited but can be determined suitably. With respect to 100 parts by weight of the material for forming the hard-coating layer, the ratio of the fine particles to be added is, for example, 2 to 70 parts by weight, preferably 15 to 40 parts by weight.

The average tilt angle θa of the unevenness of the hard-coating layer surface is preferably in the range of 0.4° to 1.5°. If the average tilt angle θa is at least 0.4°, excellent antiglare properties can be obtained. An average tilt angle θa of at most 1.5° allows the haze value to be obtained in a suitable range. In the present invention, the average tilt angle θa can be controlled by suitably selecting, for example, the type of the resin for forming the hard-coating layer, the thickness of the hard-coating layer, the type of the fine particles, the average particle size of the fine particles, etc. The average tilt angle θa in the predetermined range of the present invention can be controlled without carrying out an undue amount of trial and error.

In the present invention, the average tilt angle θa is a value defined by Expression (1) indicated below. The average tilt angle θa is a value measured by the method described later in the section of Examples.
Average tilt angle θa=tan⁻¹ Δa (1)

In Expression (1) described above, as indicated in Expression (2) below, Δa denotes a value obtained by dividing the sum total (h1+h2+h3 . . . +hn) of the differences (heights h) between adjacent peaks and the lowest point of the trough formed therebetween by the standard length L of the roughness curve defined in JIS B 0601 (1994 version). The roughness curve is a curve obtained by removing the surface waviness components with longer wavelengths than the predetermined one from the profile curve using a retardation compensation high-pass filter. The profile curve denotes a profile that appears at the cut surface when an object surface was cut in a plane perpendicular to the object surface. FIG. 5 shows examples of the roughness curve, height h, and standard line L.
Δa=(h1+h2+h3 . . . +hn)/L (2)

In the unevenness of the hard-coating layer, the arithmetic average surface roughness Ra is, for example, in the range of 0.05 to 0.3, preferably in the range of 0.07 to 0.2, and more preferably in the range of 0.09 to 0.15. The arithmetic average surface roughness Ra is one defined in JIS B 0601 (1994 version). The arithmetic average surface roughness Ra is measured by, for instance, the method described later in the section of Examples. In the present invention, the arithmetic average surface roughness Ra can be controlled by suitably selecting, for example, the type of the resin for forming the hard-coating layer, the thickness of the hard-coating layer, the type of fine particles, the weight average particle size of the fine particles, etc. The arithmetic average surface roughness Ra can be controlled in the aforementioned predetermined ranges without carrying out an undue amount of trial and error.

The thickness of the hard-coating layer is, preferably, 15 to 25 μm. When the thickness is in the aforementioned predetermined ranges, the hard-coating layer has sufficiently high hardness (for example, a pencil hardness of at least 4H). In addition, curling can be prevented from occurring further effectively, as long as the thickness is in the predetermined ranges. The thickness of the hard-coating layer is, more preferably, 18 to 23 μm.

The hard-coated film of the present invention can be manufactured by, for example, preparing a material for forming the hard-coating layer containing the aforementioned three components that have been dissolved or dispersed in a solvent, forming a coating film by applying the material for forming the hard-coating layer onto at least one surface of the transparent plastic film substrate, and forming the hard-coating layer by curing the coating film.

The solvent is not particularly limited. Examples of the solvent include dibutyl ether, dimethoxymethane, dimethoxyethane, diethoxyethane, propylene oxide, 1,4-dioxane, 1,3-dioxolane, 1,3,5-trioxane, tetrahydrofuran, acetone, methyl ethyl ketone, diethyl ketone, dipropyl ketone, diisobutyl ketone, cyclopentanone, cyclohexanone, methylcyclohexanone, ethyl formate, propyl formate, n-pentyl formate, methyl acetate, ethyl acetate, methyl propionate, ethyl propionate, n-pentyl acetate, acetyl acetone, diacetone alcohol, methyl acetoacetate, ethyl acetoacetate, methanol, ethanol, 1-propanol, 2-propanol, 1-butanol, 2-butanol, 1-pentanol, 2-methyl-2-butanol, cyclohexanol, isobutyl acetate, methyl isobutyl ketone (MIBK), 2-octanone, 2-pentanone, 2-hexanone, 2-heptanone, 3-heptanone, ethylene glycol monoethyl ether acetate, ethylene glycol monoethyl ether, ethylene glycol monobutyl ether, ethylene glycol monomethyl ether, propylene glycol monomethyl ether acetate, propylene glycol monomethyl ether, etc. One of these solvents or any combination of two or more of these solvents may be used. From the viewpoint of improving the adhesion between the transparent plastic film substrate and the hard-coating layer, the solvent contains ethyl acetate whose ratio to the total weight of solvent is preferably at least 20% by weight, more preferably at least 25% by weight, and most preferably 30 to 70% by weight. When the ratio of the ethyl acetate in the solvent is 70% by weight or less, the solvent can have a suitable rate of volatilization and thereby unevenness in coating or drying can be effectively prevented from occurring. The type of the solvent to be used in combination with the ethyl acetate is not particularly limited. Examples of the solvent include butyl acetate, methyl ethyl ketone, ethylene glycol monobutyl ether, propylene glycol monomethyl ether, etc.

Various types of leveling agents can be added to the material for forming the hard-coating layer. The leveling agent may be, for example, a fluorochemical or silicone leveling agent, preferably a silicone leveling agent. Examples of the silicon leveling agent include a reactive silicone, polydimethylsiloxane, polyether-modified polydimethylsiloxane, polymethylalkylsiloxane, etc. Among these silicone leveling agents, the reactive silicone is particularly preferred. The reactive silicone added can impart lubricity to the surface and produce continuous scratch resistance over a long period of time. In the case of using a reactive silicone containing a hydroxyl group, when an antireflection layer (a low refractive index layer) containing a siloxane component is formed on the hard-coating layer, the adhesion between the antireflection layer and the hard-coating layer is improved.

The amount of the leveling agent to be added can be, for example, at most 5 parts by weight, preferably in the range of 0.01 to 5 parts by weight, with respect to 100 parts by weight of all the resin components.

If necessary, the material for forming the hard-coating layer may contain a pigment, a filler, a dispersing agent, a plasticizer, an ultraviolet absorbing agent, a surfactant, an antioxidant, a thixotropy-imparting agent, or the like, as long as the performance is not degraded. One of these additives may be used alone, or two or more of these additives may be used together.

The material for forming the hard-coating layer can contain any conventionally known photopolymerization initiator. Examples of the applicable photopolymerization initiator include 2,2-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzyl dimethyl ketal, N,N,N′,N′-tetramethyl-4,4′-diaminobenzophenone, 1-(4-isopropylphenyl)-2-hydroxy-2-methylpropane-1-one, and other thioxanthone compounds.

The material for forming the hard-coating layer may be applied onto the transparent plastic film substrate by any coating method such as fountain coating, die coating, spin coating, spray coating, gravure coating, roll coating, bar coating, etc.

The material for forming the hard-coating layer is applied to form a coating film on the transparent plastic film substrate and then the coating film is cured. Preferably, the coating film is dried before being cured. The drying can be carried out by, for example, allowing it to stand, air drying by blowing air, drying by heating, or a combination thereof.

While the coating film formed of the material for forming the hard-coating layer may be cured by any method, ionizing radiation curing is preferably used. While any type of activation energy may be used for such curing, ultraviolet light is preferably used. Preferred examples of the energy radiation source include high-pressure mercury lamps, halogen lamps, xenon lamps, metal halide lamps, nitrogen lasers, electron beam accelerators, and radioactive elements. The amount of irradiation with the energy radiation source is preferably 50 to 5000 mJ/cm² in terms of accumulative exposure at an ultraviolet wavelength of 365 nm. When the amount of irradiation is at least 50 mJ/cm², the material for forming the hard-coating layer can be sufficiently cured and the resulting hard-coating layer also has a sufficiently high hardness. When the amount of irradiation is at most 5000 mJ/cm², the resulting hard-coating layer can be prevented from being colored and thereby can have improved transparency.

The pressure-sensitive adhesive for forming the pressure-sensitive adhesive layer of the present invention to be used can be one selected suitably from those containing, as a base polymer, acrylic polymer, silicone polymer, polyester, polyurethane, polyamide, polyvinyl ether, vinyl acetate/vinyl chloride copolymer, modified polyolefin, epoxy polymer, fluorinated polymer, or rubber polymer, such as natural rubber and synthetic rubber. Particularly, an acrylic polymer is used preferably because it has excellent optical transparency, exhibits an appropriate wettability and cohesiveness, and is excellent in weather resistance and heat resistance.

The acrylic polymer can be prepared by using a suitable polymerization method, such as solution polymerization, emulsion polymerization, mass polymerization, or suspension polymerization, with respect to a mixture of component monomers, for example. Acrylic polymers that can be used preferably in the present invention are those having a weight average molecular weight in the range of 100000 or more, preferably 200000 to 2000000, and more preferably 300000 to 1500000 from the viewpoints of, for example, heat resistance and adhesive properties.

Additives such as, for example, an antioxidant and resins of natural products or compounds can be mixed in the pressure-sensitive adhesive layer to control, for example, the aforementioned properties and adhesion if necessary. Furthermore, the pressure-sensitive adhesive layer can have a multilayered structure in which a plurality of layers that are different in composition or type from each other are stacked together. The thickness of the pressure-sensitive adhesive layer can be determined according to the adhesion and the surface roughness of the transparent plastic film substrate or the part to which the pressure-sensitive adhesive layer is to be bonded. It is preferably 1 to 500 μm, more preferably 3 to 100 μm, particularly preferably 5 to 50 μm.

The adhesion of the pressure-sensitive adhesive layer of the present invention is 3 N/50 mm or lower, more preferably in the range of 0.01 to 2 N/50 mm, and particularly preferably 0.05 to 1.5 N/50 mm in terms of adhesion to triacetyl cellulose obtained according to the 180-degree peeling test carried out at a peeling rate of 20 m/min at normal temperature.

The pressure-sensitive adhesive layer can be formed by preparing a material for forming a pressure-sensitive adhesive layer by dissolving or dispersing a base polymer of a pressure-sensitive adhesive and other additives in a solvent, applying it to the other surface (the surface on which the hard-coating layer is not formed) of the transparent plastic film substrate, and drying it, for example.

As described above, the hard-coating layer is formed on one surface of the transparent plastic film substrate and the pressure-sensitive adhesive layer is formed on the other surface of the transparent plastic film substrate. Thus, the hard-coated film of the present invention can be produced. The hard-coated film of the present invention also can be produced by production methods other than that described above. The hardness of the hard-coated film of the present invention is, for example, at least 4H in terms of pencil hardness.

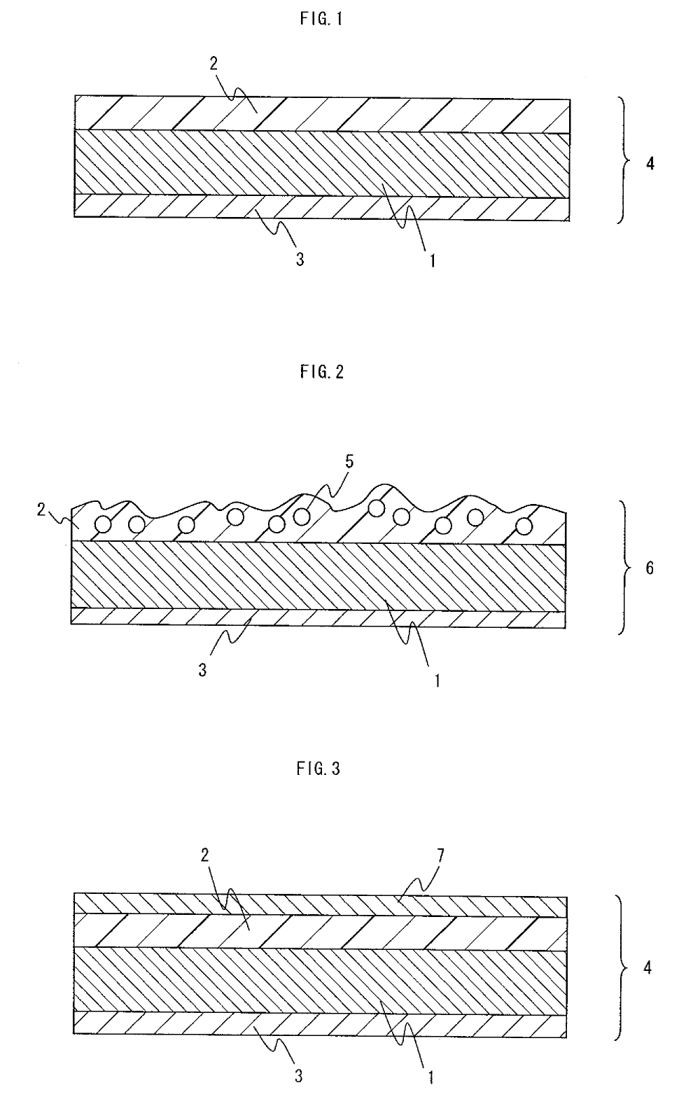

FIG. 1 shows a configuration diagram of an example of the hard-coated film according to the present invention. As shown in FIG. 1, the hard-coated film 4 of this example includes a transparent plastic film substrate 1, a hard-coating layer 2 formed on one surface of the transparent plastic film substrate 1, and a pressure-sensitive adhesive layer 3 formed on the other surface. The hard-coating layer 2 and the pressure-sensitive adhesive layer 3 of this example each are a monolayer. However, the present invention is not limited to this. The hard-coating layer 2 and the pressure-sensitive adhesive layer 3 each can have a multilayered structure including at least two layers stacked together.

As described above, in the hard-coated film of the present invention, the outer surface of the hard-coating layer can have an uneven structure. An example of such a hard-coated film is shown in FIG. 2. In FIG. 2, the identical parts to those shown in FIG. 1 are indicated with identical numerals. As shown in FIG. 2, in this hard-coated film 6, a hard-coating layer 2 containing fine particles 5 is formed on one surface of a transparent plastic film substrate 1 and a pressure-sensitive adhesive layer 3 is formed on the other surface. The outer surface of the hard-coating layer 2 has an uneven structure due to the fine particles 5. This allows antiglare properties to be exhibited.

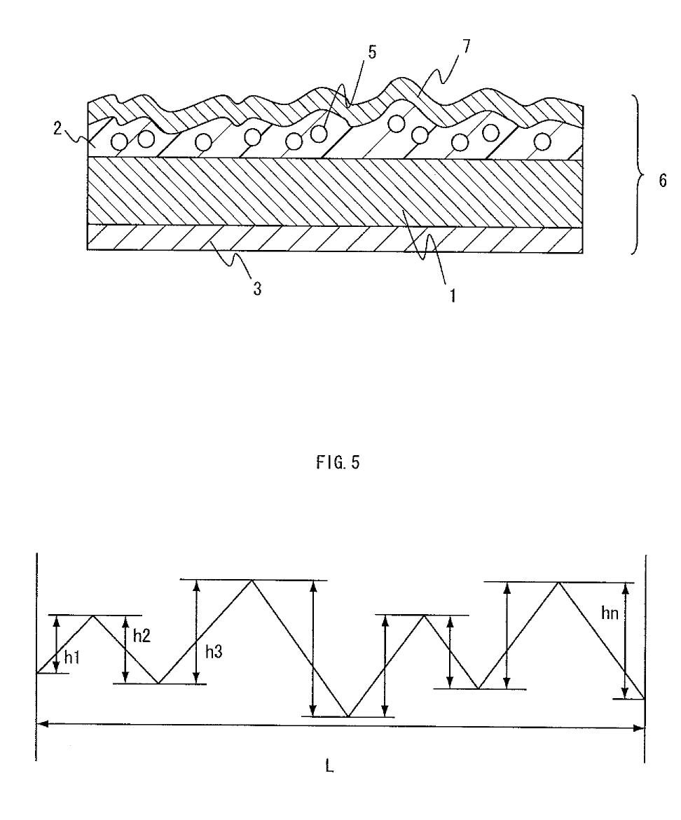

In the hard-coated film of the present invention, an antireflection layer (low-refractive-index layer) can be disposed on the hard-coating layer. FIGS. 3 and 4 each show an example of the hard-coated film of the present invention including an antireflection layer. In FIGS. 3 and 4, identical parts to those shown in FIGS. 1 and 2 are indicated with identical numerals. The examples of the hard-coated film shown in FIGS. 3 and 4 are those obtained by forming antireflection layers 7 in the hard-coated films shown in FIGS. 1 and 2, respectively. Light incident on an object undergoes reflection at the interface and is absorbed and scattered repeatedly inside the object while traveling through it to reach the back side thereof. For example, when a hard-coated film is attached to an image display, one of the factors of reducing the visibility of an image is light reflection at the interface between air and the hard-coating layer. The antireflection layer reduces the surface reflection. The antireflection layers shown in FIGS. 3 and 4 each have a monolayer structure, but the present invention is not limited to this. They can have a multilayer structure including at least two layers.

In the present invention, the antireflection layer is a thin optical film having a strictly controlled thickness and refractive index, or a laminate including at least two layers of the thin optical films that are stacked together. In the antireflection layer, the antireflection function is produced by allowing opposite phases of incident light and reflected light to cancel each other out based on interference of light. The antireflection function should be produced in the visible light wavelength range of 380 to 780 nm, and the visibility is particularly high in the wavelength range of 450 to 650 nm. Preferably, the antireflection layer is designed to have a minimum reflectance at the center wavelength 550 nm of the range.

When the antireflection layer is designed based on interference of light, the interference effect can be enhanced by a method of increasing the difference in refractive index between the antireflection layer and the hard-coating layer. In an antireflection multilayer including two to five thin optical layers (each with strictly controlled thickness and refractive index) that are stacked together, components with different refractive indices from each other are used to form a plurality of layers with a predetermined thickness. Thus, the antireflection layer can be optically designed at a higher degree of freedom, the antireflection effect can be enhanced, and in addition, the spectral reflection characteristics can be made flat in the visible light range. Since each layer of the thin optical film must be precise in thickness, a dry process such as vacuum deposition, sputtering, CVD, etc. may be used to form each layer.

For the antireflection multilayer, a two-layer laminate is preferred, including a high-refractive-index titanium oxide layer (refractive index: about 1.8) and a low-refractive-index silicon oxide layer (refractive index: about 1.45) formed on the titanium oxide layer. A four-layer laminate is more preferable wherein a silicon oxide layer is formed on a titanium oxide layer, another titanium oxide is formed thereon, and then another silicon oxide layer is formed thereon. The formation of the antireflection layer of such a two- or four-layer laminate can evenly reduce reflection over the visible light wavelength range (for example, 380 to 780 nm).

The antireflection effect can also be produced by forming a thin monolayer optical film (an antireflection layer) on the hard-coating layer. The antireflection monolayer is preferably formed using a coating method such as a wet process, for example, fountain coating, die coating, spin coating, spray coating, gravure coating, roll coating, or bar coating.

Examples of the material for forming an antireflection monolayer include: resin materials such as UV-curable acrylic resins; hybrid materials such as a dispersion of inorganic fine particles such as colloidal silica in a resin; and sol-gel materials containing metal alkoxide such as tetraethoxysilane and titanium tetraethoxide. Preferably, the material contains a fluorine group to impart anti-fouling surface properties. In terms of, for example, scratch resistance, the material preferably contains a large amount of an inorganic component, and the sol-gel materials are more preferable. Partial condensates of the sol-gel materials can be used.

Preferable antireflection layers (low-refractive-index layers) are those formed of a material (a material described in JP-A No. 2004-167827) that contains siloxane oligomer with an ethylene glycol-equivalent number average molecular weight of 500 to 10000 and a fluorine compound having a polystyrene-equivalent number average molecular weight of at least 5000 and having a fluoroalkyl structure and a polysiloxane structure because, for example, both scratch resistance and low reflection can be obtained.

The antireflection layer (the low-refractive-index layer) may contain an inorganic sol for increasing film strength. The inorganic sol is not particularly limited. Examples thereof include silica, alumina, magnesium fluoride, etc. Particularly, silica sol is preferred. The amount of the inorganic sol to be added can be, for example, in the range of 10 to 80 parts by weight, based on 100 parts by weight of the total solids of the material for forming the antireflection layer. The size of the inorganic fine particles in the inorganic sol is preferably in the range of 2 to 50 nm, more preferably 5 to 30 nm.

The material for forming the antireflection layer preferably contains hollow spherical silicon oxide ultrafine particles. The silicon oxide ultrafine particles have preferably an average particle size of 5 to 300 nm, more preferably 10 to 200 nm. The silicon oxide ultrafine particles are preferably in the form of hollow spheres each including a pore-containing outer shell in which a hollow is formed. The hollow contains at least one of a solvent and a gas that has been used for preparing the ultrafine particles. A precursor substance for forming the hollow of the ultrafine particle preferably remains in the hollow. The thickness of the outer shell is preferably in the range of about 1 to about 50 nm and in the range of approximately 1/50 to ⅕ of the average particle size of the ultrafine particles. The outer shell preferably includes a plurality of coating layers. In the ultrafine particles, the pore is preferably blocked, and the hollow is preferably sealed with the outer shell. This is because the antireflection layer holding a porous structure or a hollow of the ultrafine particles can have a reduced refractive index of the antireflection layer. The method of producing such hollow spherical silicon oxide ultrafine particles is preferably a method of producing silica fine particles as disclosed in JP-A No. 2000-233611, for example.

In the process of forming the antireflection layer (the low-refractive-index layer), while drying and curing may be performed at any temperature, they are preferably performed at a temperature of, for example, 60 to 150° C., preferably 70 to 130° C., for a time period of, for example, 1 minute to 30 minutes, preferably 1 minute to 10 minutes in view of productivity. After drying and curing, the layer may be further heated, so that a hard-coated film of high hardness including an antireflection layer can be obtained. While the heating may be performed at any temperature, it is preferably performed at a temperature of, for example, 40 to 130° C., preferably 50 to 100° C., for a time period of, for example, 1 minute to 100 hours, more preferably at least 10 hours in terms of improving scratch resistance. The temperature and the time period are not limited to the above ranges. The heating can be performed by a method using a hot plate, an oven, a belt furnace, or the like.

When the hard-coated film including the antireflection layer is attached to an image display, the antireflection layer may frequently serve as the uppermost surface and thus tends to be susceptible to stains from the external environment. Stains are more conspicuous on the antireflection layer than on, for instance, a simple transparent plate. In the antireflection layer, for example, deposition of stains such as fingerprints, thumbmarks, sweat, and hairdressings changes the surface reflectance, or the deposition stands out whitely to make the displayed content unclear. Preferably, an antistain layer formed of a fluoro-silane compound, a fluoro-organic compound, or the like is layered on the antireflection layer in order to impart the functions of antideposition and easy elimination of the stains.

The hard-coated film of the present invention can be bonded to an optical member that is used for the display surface of an image display such as an LCD or ELD, through the pressure-sensitive adhesive layer.

For example, the optical component can be a polarizer or a polarizing plate. A polarizing plate including a polarizer and a transparent protective film formed on one or both surfaces of the polarizer may be used. If the transparent protective film is formed on both surfaces of the polarizer, the front and rear transparent protective films may be made of the same material or different materials. Polarizing plates are may be placed on both surfaces of a liquid crystal cell. Polarizing plates may be arranged such that the absorption axes of two polarizing plates are substantially perpendicular to each other.

Next, an optical member in which a hard-coated film of the present invention is stacked is described using a polarizing plate as an example. A polarizing plate with the functions of the present invention can be obtained by stacking a hard-coated film of the present invention with a polarizer or a polarizing plate through the pressure-sensitive adhesive layer thereof.

The polarizer is not particularly limited. Examples of the polarizer include: a film that is uniaxially stretched after a hydrophilic polymer film, such as a polyvinyl alcohol type film, a partially formalized polyvinyl alcohol type film, an ethylene-vinyl acetate copolymer type partially saponified film, etc., is allowed to adsorb dichromatic substances such as iodine and a dichromatic dye; and polyene type oriented films, such as a dehydrated polyvinyl alcohol film, a dehydrochlorinated polyvinyl chloride film, etc. A polarizer formed of a polyvinyl alcohol type film and a dichromatic material such as iodine is preferred because it has a high polarization dichroic ratio. Although the thickness of the polarizer is not especially limited, the thickness of about 5 to 80 μm may be used.

A polarizer that is uniaxially stretched after a polyvinyl alcohol type film is dyed with iodine can be produced by dipping and dyeing a polyvinyl alcohol type film in an aqueous solution of iodine and then stretching it by 3 to 7 times the original length. The aqueous solution of iodine may contain boric acid, zinc sulfate, zinc chloride, etc., if necessary. Separately, the polyvinyl alcohol type film may be dipped in an aqueous solution containing boric acid, zinc sulfate, zinc chloride, etc. Furthermore, before dyeing, the polyvinyl alcohol type film may be dipped in water and rinsed if needed. Rinsing the polyvinyl alcohol type film with water allows soils and blocking inhibitors on the polyvinyl alcohol type film surface to be washed off and also provides an effect of preventing non-uniformity, such as unevenness of dyeing, that may be caused by swelling the polyvinyl alcohol type a film. Stretching may be applied after dyeing with iodine or may be applied concurrently with dyeing, or conversely, dyeing with iodine may be applied after stretching. Stretching can be carried out in aqueous solutions, such as boric acid, potassium iodide, etc. or in water baths.

The transparent protective film formed on one or both surfaces of the polarizer preferably is excellent in transparency, mechanical strength, thermal stability, moisture-blocking properties, retardation value stability, or the like. Examples of the material for forming the transparent protective film include the same materials as those used for the transparent plastic film substrate.

Moreover, the polymer films described in JP-A No. 2001-343529 (WO01/37007) also can be used as the transparent protective film. The polymer films described in JP-A No. 2001-343529 are formed of, for example, resin compositions including (A) thermoplastic resins having at least one of a substituted imide group and a non-substituted imide group in the side chain thereof, and (B) thermoplastic resins having at least one of a substituted phenyl group and a non-substituted phenyl group and a nitrile group in the side chain thereof. Examples of the polymer films formed of the resin compositions described above include one formed of a resin composition including: an alternating copolymer containing isobutylene and N-methyl maleimide; and an acrylonitrile-styrene copolymer. The polymer film can be produced by extruding the resin composition in the form of film. The polymer film exhibits a small retardation and a small photoelastic coefficient and thus can eliminate defects such as unevenness due to distortion when used as a protective film for a polarizing plate or the like. The polymer film also has low moisture permeability and thus has high durability against moisture penetration.

In terms of polarizing properties, durability, and the like, cellulose resins such as triacetyl cellulose and norbornene resins are preferably used for the transparent protective film. Examples of the transparent protective film that are commercially available include FUJITAC (trade name) manufactured by Fuji Photo Film Co., Ltd., ZEONOR (trade name) manufactured by Nippon Zeon Co., Ltd., and ARTON (trade name) manufactured by JSR Corporation.

The thickness of the transparent protective film is not particularly limited. It can be, for example, in the range of 1 to 500 μm from the viewpoints of strength, workability such as a handling property, a thin layer property, etc. In the above range, the transparent protective film can mechanically protect a polarizer and can prevent a polarizer from shrinking and retain stable optical properties even when exposed to high temperature and high humidity. The thickness of the transparent protective film is preferably in the range of 5 to 200 μm and more preferably 10 to 150 μm.

The polarizing plate in which the hard-coated film is stacked is not particularly limited. The polarizing plate may be a laminate of the hard-coated film, the transparent protective film, the polarizer, and the transparent protective film that are stacked in this order or a laminate of the hard-coated film, the polarizer, and the transparent protective film that are stacked in this order. Preferably, an adhesive layer or a pressure-sensitive adhesive layer is formed on one or both surfaces of the polarizer to be bonded to such as the liquid crystal cell easily.

Hard-coated films of the present invention and various optical devices, such as polarizing plates, including the hard-coated films can be preferably used in various image displays such as a liquid crystal display, etc. The liquid crystal display of the present invention has the same configuration as those of conventional liquid crystal displays except for including a hard-coated film of the present invention. The liquid crystal display of the present invention can be manufactured by suitably assembling several parts such as a liquid crystal cell, optical components such as a polarizing plate, and, if necessity, lighting system (for example, a backlight), and incorporating a driving circuit, for example. The liquid crystal cell is not particularly limited. The liquid crystal cell can be of any type such as TN type, STN type, π type, etc.

In the present invention, the configurations of liquid crystal displays are not particularly limited. The liquid crystal displays of the present invention include, for example, one in which the optical device is disposed on one side or both sides of a liquid crystal cell, one in which a backlight or a reflector is used for a lighting system, etc. In these liquid crystal displays, the optical device of the present invention can be disposed on one side or both sides of the liquid crystal cell. When disposing the optical devices in both the sides of the liquid crystal cell, they may be identical to or different from each other. Furthermore, various optical components and optical parts such as a diffusion plate, an antiglare layer, an antireflection film, a protective plate, a prism array, a lens array sheet, an optical diffusion plate, backlight, etc. may be disposed in the liquid crystal displays.

### EXAMPLES

Next, examples of the present invention are described together with comparative examples. However, the present invention is not limited by the following examples and comparative examples.

### Example 1

A resin material (GRANDIC PC1071 (trade name), manufactured by DAINIPPON INK AND CHEMICALS, INCORPORATED) was prepared. The resin material contained a resin component containing Component A, Component B, Component C and a photopolymerization initiator in a mixed solvent at a solid concentration of 66% by weight. Then 0.5% by weight of a leveling agent (GRANDIC PC-F479 (trade name), manufactured by DAINIPPON INK AND CHEMICALS, INCORPORATED) was added thereto. This mixture was diluted with ethyl acetate in such a manner that a solid concentration of 55% by weight was obtained. Thus, a material for forming a hard-coating layer was prepared.
Component A: urethane acrylate produced with pentaerythritol acrylate and hydrogenated xylene isocyanate (100 parts by weight)
Component B: 49 parts by weight of dipentaerythritol hexaacrylate, 41 parts by weight of pentaerythritol tetraacrylate, and 24 parts by weight of pentaerythritol triacrylate
Component C: a polymer or copolymer having a repeating unit represented by General Formula (1) described above, or a mixture of the polymer and copolymer (59 parts by weight)
Photopolymerization initiator: IRGACURE 184 (trade name, manufactured by CIBA SPECIALTY CHEMICALS), 3 parts by weight
Mixed solvent:butyl acetate:ethyl acetate (weight ratio)=89:11

The material for forming a hard-coating layer was applied onto a transparent plastic film substrate (a triacetyl cellulose film with a thickness of 80 μm and a refractive index of 1.48) with a bar coater. Thus, a coating film was formed. After the application, it was heated at 100° C. for one minute and thus the coating film was dried. Thereafter, it was irradiated with ultraviolet light at an accumulated light intensity of 300 mJ/cm² using a high pressure mercury lamp and thereby the coating film was cured to form a 20-μm thick hard-coating layer.

Three parts by weight of a cross-linking agent (Colonate L, manufactured by Nippon Polyurethane Industry Co., Ltd.) per 100 parts by weight of solid content of a polymer solution was added to the polymer solution. The polymer solution was composed of 100 parts by weight of isononyl acrylate, 4 parts by weight of 2-hydroxyethyl acrylate, 0.3 part by weight of azobisisobutyronitrile, and 100 parts by weight of ethyl acetate. It was heated at 60° C. for eight hours and further was heat-treated at 70° C. for two hours. Thus, an acrylic polymer pressure-sensitive adhesive was prepared. The pressure-sensitive adhesive had a weight average molecular weight of 650000.

The acrylic polymer pressure-sensitive adhesive was applied onto the surface of the plastic film substrate on which the hard-coating layer was not formed, using an applicator, and thereby a coating film was formed. It was heated at 120° C. for five minutes to be dried and thereby a 22-μm thick pressure-sensitive adhesive layer was formed. Thus, an inventive hard-coated film was obtained.

### Example 2

A hard-coated film was obtained in the same manner as in Example 1 except that the transparent plastic film substrate was changed to a polyethylene terephthalate film (with a thickness of 125 μm and a refractive index of 1.64).

### Example 3

A resin material (GRANDIC PC1071 (trade name), manufactured by DAINIPPON INK AND CHEMICALS, INCORPORATED) was prepared. The resin material contained a resin component containing Component A, Component B, Component C and a photopolymerization initiator in a mixed solvent at a solid concentration of 66% by weight. Then 30 parts by weight of PMMA particles whose weight average particle size was 10 μm (a refractive index of 1.49), and 0.1 parts by weight of a leveling agent (GRANDIC PC-F479 (trade name), manufactured by DAINIPPON INK AND CHEMICALS, INCORPORATED) were added and mixed to 100 parts by weight of solid content of the resin material described. This mixture was diluted with ethyl acetate in such a manner that a solid concentration of 55% by weight was obtained. Thus, a material for forming a hard-coating layer was prepared.
Component A: urethane acrylate produced with pentaerythritol acrylate and hydrogenated xylene isocyanate (100 parts by weight)
Component B: 49 parts by weight of dipentaerythritol hexaacrylate, 41 parts by weight of pentaerythritol tetraacrylate, and 24 parts by weight of pentaerythritol triacrylate
Component C: a polymer or copolymer having a repeating unit represented by General Formula (1) described above, or a mixture of the polymer and copolymer (59 parts by weight)
Photopolymerization initiator: IRGACURE 184 (trade name, manufactured by CIBA SPECIALTY CHEMICALS), 3 parts by weight
Mixed solvent:butyl acetate:ethyl acetate (weight ratio)=89:11

The material for forming a hard-coating layer was applied onto a transparent plastic film substrate (a triacetyl cellulose film with a thickness of 80 μm and a refractive index of 1.48) with a bar coater. Thus, a coating film was formed. After the application, it was heated at 100° C. for one minute and thus the coating film was dried. Thereafter, it was irradiated with ultraviolet light at an accumulated light intensity of 300 mJ/cm² using a high pressure mercury lamp and thereby the coating film was cured to form a 20-μm thick hard-coating layer.

The acrylic polymer pressure-sensitive adhesive prepared in Example 1 was applied onto the surface of a transparent plastic film substrate on which the hard-coating layer was not formed, using an applicator, and thereby a coating film was formed. It was heated at 120° C. for five minutes to be dried and thereby a 22-μm thick pressure-sensitive adhesive layer was formed. Thus, an inventive hard-coated film was obtained.

### Example 4

In this example, a hard-coated film was produced in the same manner as in Example 3 except that the addition amount of the PMMA particles was changed to 70 parts by weight.

### Comparative Example 1

In this comparative example, a hard-coated film was produced in the same manner as in Example 1 except that 22 parts by weight of pentaerythritol tetraacrylate and 5 parts by weight of pentaerythritol triacrylate were used as Component B and 133 parts by weight of a polymethyl methacrylate acrylate polymer was used in place of Component C.

### Comparative Example 2

In this comparative example, a hard-coated film was produced in the same manner as in Example 1 except that 22 parts by weight of pentaerythritol tetraacrylate and 5 parts by weight of pentaerythritol triacrylate were used as Component B and 55 parts by weight of a polymethyl methacrylate polymer was used in place of Component C.

### Evaluation

In the respective examples and comparative examples, various characteristics were evaluated or measured by the following methods.

Weight Average Molecular Weight

The weight average molecular weight was measured by GPC. The measurement conditions for GPC were as follows:
Measuring apparatus: HLC-8120GPC (trade name) manufactured by TOSOH CORPORATION
Columns: G4000H_{XL} (trade name)+G2000H_{XL} (trade name)+G1000H_{XL} (trade name) (each having 7.8 mmφ×30 cm, a total of 90 cm) manufactured by TOSOH CORPORATION
Column temperature: 40° C.
Eluent: tetrahydrofuran
Flow rate: 0.8 ml/min
Inlet pressure: 6.6 MPa
Standard sample: polystyrene
   Refractive Indices of Transparent Plastic Film Substrate and Hard-Coating Layer

The refractive indices of the transparent plastic film substrate and hard-coating layer were measured using an Abbe refractometer (trade name: DR-M2/1550) manufactured by Atago Co., Ltd. according to the measuring method prescribed for the apparatus, with monobromonaphthalene being selected as an intermediate liquid, and with measuring light being allowed to be incident on the measuring planes of the film substrate and hard-coating layer.

Refractive Index of Fine Particles

Fine particles were placed on a slide glass, and a refractive index standard solution was dropped on the fine particles. Thereafter, a cover glass was placed thereon. Thus, a sample was prepared. The sample was observed with a microscope and thereby the refractive index of the refractive index standard solution that was obtained at the point where the profiles of the fine particles were most difficult to view at the interface with the refractive index standard solution was used as the refractive index of the fine particles.

Weight Average Particle Size of Fine Particles

By the Coulter counting method, a particle size distribution measurement apparatus (trade name: COULTER MULTISIZER, manufactured by BECKMAN COULTER, INC.) using a pore electrical resistance method was employed to measure electrical resistance of an electrolyte corresponding to the volumes of the fine particles when the fine particles passed through the pores. Thus, the number and volume of the fine particles were measured and then the weight average particle size of the fine particles was calculated.

Thickness of Hard-Coating Layer

A thickness gauge (microgauge type manufactured by MITUTOYO CORPORATION) was used to measure the total thickness of the hard-coated film. The thickness of the transparent plastic film substrate was subtracted from the total thickness. Thus, the thickness of the hard-coating layer was calculated.

Pencil Hardness

A glass sheet was bonded to the hard-coated film, with the pressure-sensitive adhesive layer. Thus, a sample was prepared. Thereafter, the pencil hardness of the surface of the hard-coating layer of the sample was measured according to the pencil hardness test described in JIS K-5400 (with a load of 500 g).

Haze

A haze meter HR300 (manufactured by MURAKAMI COLOR RESEARCH LABORATORY) was used to measure haze according to JIS-K7136 (haze (cloudiness)). The measurement of the haze was carried out with respect to Examples 3 and 4 only.

Arithmetic Average Surface Roughness Ra and Average Tilt Angle θa

A hard-coated film was bonded to glass (with a thickness of 1.3 mm) manufactured by MATSUNAMI GLASS IND., LTD., through the pressure-sensitive adhesive layer thereof The uneven structure of the outer surface of the hard-coating layer was measured using a high-precision micro figure measuring instrument (SURFCORDER ET4000 (trade name), manufactured by KOSAKA LABORATORY LTD.) and the Ra value and θa value were determined. The high precision micro figure measuring instrument automatically calculates values of the arithmetic average surface roughness Ra and average tilt angle θa. Both the surface roughness parameters are according to JIS B 0601 (1994 version). The measurements of the Ra and θa values were carried out with respect to Examples 3 and 4 only.

Curling

Each hard-coated film was cut into 10 cm square pieces and thereby test pieces were prepared. The test piece was placed on a glass plate with its hard-coating layer (or antireflection layer) facing upward. The length (mm) of elevation of each of the four corners of the test piece from the glass plate was measured. The average value of the measurement values was used as an index for the evaluation of curling. The rounded piece was defined as “unmeasurable”.

Scratch Resistance

The scratch resistance of the hard-coated film was evaluated by the following test.

(1) A hard-coated film was cut into a piece of at least 25 mm width and at least 100 mm length. This was placed on a glass plate, which was used as a measurement sample. First, the initial haze value of this measurement sample was measured by the aforementioned method.

(2) Steel wool #0000 was attached uniformly onto a smooth cross section of a cylinder with a diameter of 25 mm. This was reciprocated 100 times at a speed of approximately 100 mm/sec on the surface of the hard-coating layer of the measurement sample under a load of 1.5 kg.

Then the Haze Value After the Scratch Test was Determined by the Aforementioned Method.

(3) The value obtained by subtracting the initial haze value from the haze value after the scratch test is used as an index of scratch resistance. In this evaluation, scratches caused at the surface of the hard-coating layer in the scratch test result in an increase in haze value after the scratch test.

Thickness of Pressure-Sensitive Adhesive Layer

A thickness gauge (microgauge type manufactured by MITUTOYO CORPORATION) was used to measure the total thickness of the pressure-sensitive adhesive layer and the substrate. The thickness of the substrate was subtracted from the total thickness. Thus, the thickness of the pressure-sensitive adhesive layer was calculated.

With respect to the respective hard-coated films of Examples 1 to 4 and Comparative Examples 1 and 2, various properties were evaluated or measured. The results are indicated in Table 1 below.

TABLE 1

| | | | | | C. | C. |
|---|---|---|---|---|---|---|
| | Ex. 1 | Ex. 2 | Ex. 3 | Ex. 4 | Ex. 1 | Ex. 2 |
| Refractive index of | 1.48 | 1.64 | 1.48 | 1.48 | 1.48 | 1.48 |
| transparent plastic | | | | | | |
| film substrate | | | | | | |
| Thickness of trans- | 80 | 125 | 80 | 80 | 80 | 80 |
| parent plastic film | | | | | | |
| substrate (μm) | | | | | | |
| Refractive index of | 1.51 | 1.51 | 1.51 | 1.51 | 1.51 | 1.51 |
| hard-coating layer | | | | | | |
| Thickness of hard- | 20 | 20 | 20 | 20 | 20 | 20 |
| coating layer (μm) | | | | | | |
| Pencil hardness | 4H | 5H | 4H | 4H | 3H | 3H |
| Curl (mm) | 22 | 6 | 10 | 10 | 0 | 20 |
| Haze | — | — | 62.5 | 65.9 | — | — |
| Ra (μm) | — | — | 0.107 | 0.157 | — | — |
| θa (degree) | — | — | 0.77 | 1.88 | — | — |
| Scratch resistance | 0.2 | 0.3 | 0.5 | 0.4 | 1.4 | 0.8 |
| Thickness of pres- | 22 | 22 | 22 | 22 | 22 | 22 |
| sure sensitive | | | | | | |
| adhesive layer (μm) | | | | | | |

As indicated in Table 1 above, the hard-coated films of all the inventive Examples each had a high hardness and excellent scratch resistance while having a thin hard-coating layer, and were prevented from curling. On the other hand, the hard-coated films of Comparative Examples 1 and 2 each had a low hardness and poor scratch resistance.

The hard-coated film of the present invention has a sufficiently high hardness, can be prevented from curling due to curing and shrinking of the hard-coating layer, and can provide a hard-coating property easily by being bonded directly to various image displays. Accordingly, the hard-coated film of the present invention can be used suitably for optical elements such as polarizing plates and various image displays such as CRTs, LCDs, PDPs, and ELDs, for example. It has no limitation in application and is applicable across a wide field.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A hard-coated film, comprising:
a transparent plastic film substrate; and
a hard-coating layer formed on one surface of the transparent plastic film substrate,
wherein the hard-coated film further includes a pressure-sensitive adhesive layer formed on the other surface of the transparent plastic film substrate, and
the hard-coating layer is formed using a material for forming the hard-coating layer containing Component A, Component B, and Component C,
where Component A is at least one of urethane acrylate and urethane methacrylate,
Component B is at least one of polyol acrylate and polyol methacrylate, and
Component C is a polymer or copolymer that is formed of at least one of Components C1 and C2, or a mixed polymer of the polymer and the copolymer,
where Component C1 is alkyl acrylate having an alkyl group containing at least one of a hydroxyl group and an acryloyl group, and
Component C2 is alkyl methacrylate having an alkyl group containing at least one of a hydroxyl group and an acryloyl group.

2. The hard-coated film according to claim 1, wherein Component B contains at least one of pentaerythritol triacrylate and pentaerythritol tetraacrylate.

3. The hard-coated film according to claim 1, wherein Component C contains a polymer or copolymer containing a repeating unit, or a mixture of the polymer and the copolymer, and the repeating unit is represented by General Formula (1) indicated below: 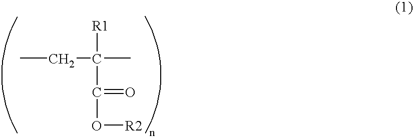
wherein in General Formula (1), R1 denotes —H or —CH₃, R2 indicates —CH₂CH₂OX or a group that is represented by General Formula (2) indicated below: 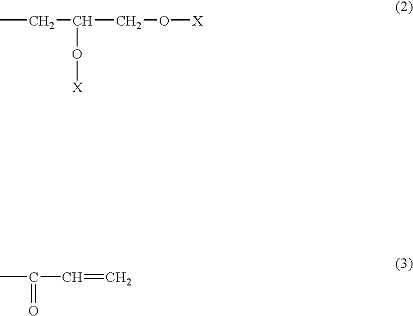
wherein X denotes —H or an acryloyl group that is represented by General Formula (3) above, and Xs are identical to or different from each other.

4. The hard-coated film according to claim 1, wherein the hard coating layer has an uneven outer surface.

5. The hard-coated film according to claim 1, further comprising an antireflection layer formed on the hard-coating layer.

6. A polarizing plate comprising a hard-coated film stacked on one side thereof,
wherein the hard-coated film is a hard-coated film according to claim 1.

7. An image display, comprising a hard-coated film according to claim 1.

8. An image display, comprising a polarizing plate according to claim 6.

9. A method of manufacturing a hard-coated film comprising a transparent plastic film substrate and a hard-coating layer formed on one surface of the transparent plastic film substrate,
wherein the method comprises:
preparing a material for forming the hard-coating layer containing Component A, Component B, and Component C that have been dissolved or dispersed in a solvent;
forming a coating film by applying the material for forming the hard-coating layer onto one surface of the transparent plastic film substrate,
forming the hard-coating layer by curing the coating film, and
forming a pressure-sensitive adhesive layer onto the other surface of the transparent plastic film substrate,
where Component A is at least one of urethane acrylate and urethane methacrylate,
Component B is at least one of polyol acrylate and polyol methacrylate, and
Component C is a polymer or copolymer that is formed of at least one of Components C1 and C2, or a mixed polymer of the polymer and the copolymer,
where Component C1 is alkyl acrylate having an alkyl group containing at least one of a hydroxyl group and an acryloyl group, and Component C2 is alkyl methacrylate having an alkyl group containing at least one of a hydroxyl group and an acryloyl group.

10. The method of manufacturing a hard-coated film according to claim 9, wherein Component B contains at least one of pentaerythritol triacrylate and pentaerythritol tetraacrylate.

11. The method of manufacturing a hard-coated film according to claim 9, wherein Component C contains a polymer or copolymer containing a repeating unit, or a mixture of the polymer and the copolymer, and the repeating unit is represented by General Formula (1) indicated below: 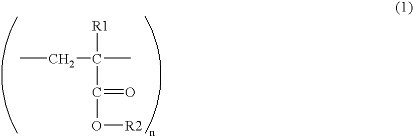
wherein in General Formula (1), R1 denotes —H or —CH₃, R2 indicates —CH₂CH₂OX or a group that is represented by General Formula (2) indicated below: 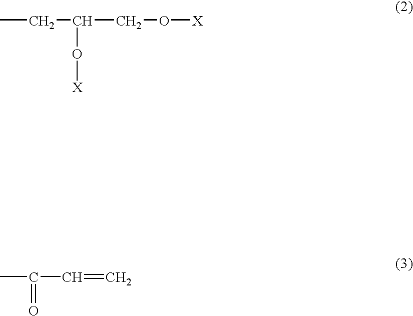
wherein X denotes —H or an acryloyl group that is represented by General Formula (3) above, and Xs are identical to or different from each other.

12. The method of manufacturing a hard-coated film according to claim 9, wherein the hard coating layer has an uneven outer surface.

13. The method of manufacturing a hard-coated film according to claim 9, further comprising an antireflection layer formed on the hard-coating layer.
